(19) United States
(12) Patent Application Publication
(10) Pub. No.: US 2021/0108979 A1
(43) Pub. Date: Apr. 15, 2021

(54) SENSOR ELEMENT

(71) Applicant: AZBIL CORPORATION, Tokyo (JP)

(72) Inventors: Hirofumi TOJO, Chiyoda-ku (JP); Masayuki YONEDA, Chiyoda-ku (JP); Tomohisa TOKUDA, Chiyoda-ku (JP); Ayumi TSUSHIMA, Chiyoda-ku (JP); Nozomi KIDA, Chiyoda-ku (JP)

(73) Assignee: AZBIL CORPORATION, Tokyo (JP)

(21) Appl. No.: 17/064,655

(22) Filed: Oct. 7, 2020

(30) Foreign Application Priority Data
Oct. 9, 2019 (JP) 2019-185768

(51) Int. Cl. G01L 13/02

(52) U.S. Cl. CPC G01L 13/025; G01L 27/002

(57) ABSTRACT

A sensor element includes diaphragms that are respectively displaced by receiving pressures, and a plurality of pressure inlet passages (a first pressure inlet passage made up of through-holes, a groove, and recessed portions, and a second pressure inlet passage made up of a through-hole, a groove, and a recessed portion) that respectively transmit same or different pressures to the diaphragms. Each of the plurality of pressure inlet passages is filled with a pressure transmission medium capable of transmitting a pressure. A pressure is applied through part or all of the plurality of pressure inlet passages to each of the diaphragms.

### CROSS-REFERENCE TO RELATED APPLICATIONS

The present application is based on and claims priority to Japanese Application No. 2019-185768, filed Oct. 9, 2019, the entire contents of which are incorporated herein by reference.

### BACKGROUND

### 1. Field of the Disclosure

The present disclosure relates to a sensor element.

### 2. Description of the Related Art

Hitherto, a semiconductor piezoresistive pressure sensor in which a piezoresistance is formed in a semiconductor diaphragm that is a pressure sensing portion is known as a pressure sensor that detects a differential pressure or a pressure (see Japanese Unexamined Patent Application Publication (Translation of PCT Application) No. 2015-512046).

For example, Japanese Unexamined Patent Application Publication (Translation of PCT Application) No. 2015-512046 describes a micromechanical measurement element that functions as a relative pressure sensor or a differential pressure sensor. However, even with the technique described in Japanese Unexamined Patent Application Publication (Translation of PCT Application) No. 2015-512046, it is not possible to measure multiple pressures of different types or the same type at a time.

### SUMMARY

The present disclosure is made to solve the above problem, and it is an object of the present disclosure to provide a sensor element capable of measuring multiple pressures at a time.

A sensor element according to an aspect of the present disclosure includes a plurality of diaphragms that are respectively displaced by receiving pressures, a plurality of pressure inlet passages that respectively transmit same or different pressures to the plurality of diaphragms, and a plurality of detection circuits that respectively output signals corresponding to displacements of the associated diaphragms. Each of the plurality of pressure inlet passages is filled with a pressure transmission medium capable of transmitting a pressure. A pressure is applied through part or all of the plurality of pressure inlet passages to each of the diaphragms.

In the sensor element according to the aspect of the present disclosure, each of the diaphragms may be displaced by receiving an absolute pressure or displaced by receiving a differential pressure.

In the sensor element according to the aspect of the present disclosure, the plurality of diaphragms may include the diaphragm that is displaced by receiving an absolute pressure and the diaphragm that is displaced by receiving a differential pressure.

In the sensor element according to the aspect of the present disclosure, all the diaphragms may be displaced by receiving absolute pressures or displaced by receiving differential pressures.

In the sensor element according to the aspect of the present disclosure, each of the detection circuits may output a signal corresponding to a displacement of the diaphragm having received an absolute pressure or a signal corresponding to a displacement of the diaphragm having received a differential pressure.

In the sensor element according to the aspect of the present disclosure, the plurality of detection circuits may include the detection circuit that outputs a signal corresponding to a displacement of the diaphragm having received an absolute pressure and the detection circuit that outputs a signal corresponding to a displacement of the diaphragm having received a differential pressure.

In the sensor element according to the aspect of the present disclosure, all the detection circuits may output signals corresponding to displacements of the diaphragms having received absolute pressures or output signals corresponding to displacements of the diaphragms having received differential pressures.

In the sensor element according to the aspect of the present disclosure, the plurality of diaphragms may include the diaphragms having different sizes.

In the sensor element according to the aspect of the present disclosure, all the diaphragms may have the same size.

In the sensor element according to the aspect of the present disclosure, the pressure inlet passages and the diaphragms may be made of silicon.

### BRIEF DESCRIPTION OF THE DRAWINGS

FIG. 1 is a plan view of a sensor element according to a first embodiment of the present disclosure;

FIG. 2 is a cross-sectional view of the sensor element according to the first embodiment of the present disclosure;

FIG. 3 is a cross-sectional view of the sensor element according to the first embodiment of the present disclosure;

FIG. 4 is a plan view of a sensor element according to a second embodiment of the present disclosure;

FIG. 5 is a cross-sectional view of the sensor element according to the second embodiment of the present disclosure;

FIG. 6 is a cross-sectional view of the sensor element according to the second embodiment of the present disclosure;

FIG. 7 is a plan view of a sensor element according to a third embodiment of the present disclosure;

FIG. 8 is a cross-sectional view of the sensor element according to the third embodiment of the present disclosure;

FIG. 9 is a cross-sectional view of the sensor element according to the third embodiment of the present disclosure;

FIG. 10 is a plan view of a sensor element according to a fourth embodiment of the present disclosure;

FIG. 11 is a cross-sectional view of the sensor element according to the fourth embodiment of the present disclosure;

FIG. 12 is a cross-sectional view of the sensor element according to the fourth embodiment of the present disclosure;

FIG. 13 is a plan view of a sensor element according to a fifth embodiment of the present disclosure;

FIG. 14 is a cross-sectional view of the sensor element according to the fifth embodiment of the present disclosure;

FIG. 15 is a cross-sectional view of the sensor element according to the fifth embodiment of the present disclosure; and

FIG. 16 is a cross-sectional view of the sensor element according to the fifth embodiment of the present disclosure.

### DETAILED DESCRIPTION

### First Embodiment

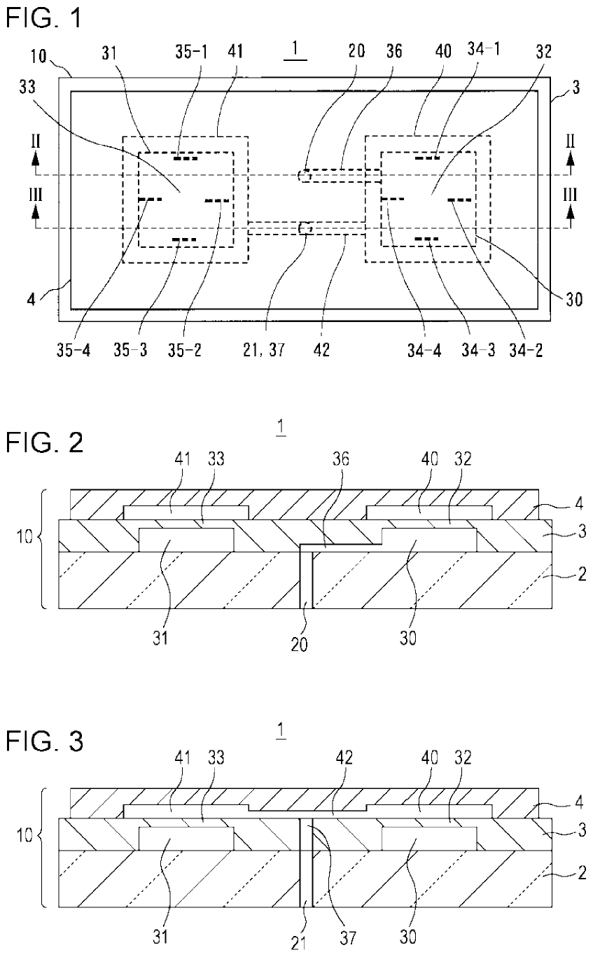

Hereinafter, an embodiment of the present disclosure will be described with reference to the attached drawings. FIG. 1 is a plan view of a sensor element according to a first embodiment of the present disclosure. FIG. 2 is a cross-sectional view taken along the line II-II in FIG. 1. FIG. 3 is a cross-sectional view taken along the line III-III in FIG. 1. The sensor element 1 is made up of a planar sensor chip 10. The sensor chip 10 is made up of a planar base 2 made of glass, a planar pressure sensing member 3 made of silicon and joined with the base 2, and a planar lid member 4 made of silicon and joined with the pressure sensing member 3.

The base 2 has two through-holes 20, 21 that extend through the base 2 from the back surface (bottom surface) to the front surface (top surface) and that serve as pressure inlet passages.

Two square recessed portions 30, 31 (pressure inlet chambers) are formed on the back surface of the pressure sensing member 3, facing the base 2. The recessed portions 30, 31 are formed by removing part of the back surface side of the pressure sensing member 3 such that the front surface side of the pressure sensing member 3 is left. Portions of the pressure sensing member 3 left on the front surface sides of regions where the recessed portions 30, 31 are formed serve as diaphragms 32, 33. A groove 36 that serves as a pressure inlet passage is formed on the back surface of the pressure sensing member 3. One end of the groove 36 communicates with the recessed portion 30, and, when the base 2 and the pressure sensing member 3 are joined with each other, the other end of the groove 36 communicates with the through-hole 20.

Strain gauges 34-1 to 34-4, 35-1 to 35-4 are formed by a technique, such as impurity diffusion and ion implantation, at the peripheral portions of the diaphragms 32, 33 formed on the front surface sides of the regions of the recessed portions 30, 31 on the front surface of the pressure sensing member 3, facing the lid member 4. The strain gauges 34-1 to 34-4, 35-1 to 35-4 function as piezoresistive elements. The strain gauges 34-1 to 34-4 are respectively formed near the middle points of the four sides of the square diaphragm 32 in plan view. Similarly, the strain gauges 35-1 to 35-4 are respectively formed near the middle points of the four sides of the square diaphragm 33 in plan view.

The pressure sensing member 3 has a through-hole 37 at a location where, when the base 2 and the pressure sensing member 3 are joined with each other, the through-hole 37 communicates with the through-hole 21. The through-hole 37 extends through the pressure sensing member 3 from the back surface to the front surface and serves as a pressure inlet passage.

Two square recessed portions 40, 41 (pressure inlet chambers) are formed on the back surface of the lid member 4, facing the pressure sensing member 3, at locations where, when the pressure sensing member 3 and the lid member 4 are joined with each other, the diaphragms 32, 33 are covered. The recessed portions 40, 41 are formed by removing part of the back surface side of the lid member 4 such that the front surface side of the lid member 4 is left. A groove 42 that serves as a pressure inlet passage is formed on the back surface of the lid member 4. One end of the groove 42 communicates with the recessed portion 40, the other end of the groove 42 communicates with the recessed portion 41, and, when the pressure sensing member 3 and the lid member 4 are joined with each other, the middle portion of the groove 42 communicates with the through-hole 37.

Of course, the through-holes 20, 21, 37, the recessed portions 30, 31, 40, 41, and the grooves 36, 42 can be easily formed by an etching technique. The through-holes, recessed portions, and grooves of the following embodiments can also be easily formed by an etching technique similarly.

The through-holes 21, 37, the groove 42, and the recessed portions 40, 41 make up a first pressure inlet passage that transmits a first pressure to first main surfaces (top surfaces) of the diaphragms 32, 33. The through-hole 20, the groove 36, and the recessed portion 30 make up a second pressure inlet passage that transmits a second pressure to a second main surface (bottom surface) of the diaphragm 32. Oil is sealed in the first and second pressure inlet passages as will be described later.

The base 2 and the pressure sensing member 3 are directly joined with each other such that the through-hole 20 of the base 2 and the groove 36 of the pressure sensing member 3 communicate with each other.

The pressure sensing member 3 and the lid member 4 are directly joined with each other such that the recessed portions 40, 41 of the lid member 4 respectively cover the diaphragms 32, 33 of the pressure sensing member 3 and the through-hole 37 of the pressure sensing member 3 and the groove 42 of the lid member 4 communicate with each other.

First oil (pressure transmission medium) is able to reach the top surfaces of the diaphragms 32, 33 via the through-holes 21, 37, the groove 42, and the recessed portions 40, 41. The first oil transmits an applied first pressure to the top surfaces of the diaphragms 32, 33. Second oil (pressure transmission medium) is able to reach the bottom surface of the diaphragm 32 via the through-hole 20, the groove 36, and the recessed portion 30. The second oil transmits an applied second pressure to the bottom surface of the diaphragms 32. The recessed portion 31 on the bottom surface of the diaphragm 33 is hermetically sealed in a vacuum state.

The planar shape of the lid member 4 is smaller than the planar shape of the pressure sensing member 3, and the front surface of the pressure sensing member 3 is exposed. Although not shown in FIG. 1, eight electrode pads are respectively electrically connected to the strain gauges 34-1 to 34-4, 35-1 to 35-4 are formed on the exposed front surface of the pressure sensing member 3. Thus, the strain gauges 34-1 to 34-4, 35-1 to 35-4 are able to be connected to external circuits. A method of connecting the strain gauges and the external circuits is also similar to those of the following embodiments.

The strain gauges 34-1 to 34-4 make up a Wheatstone bridge circuit for measuring a differential pressure together with an external circuit, that is, a detection circuit that outputs a signal corresponding to a displacement of the diaphragm 32 having received a differential pressure. With the Wheatstone bridge circuit for measuring a differential pressure, it is possible to measure a differential pressure between the first pressure applied to the top surface of the diaphragm 32 and the second pressure applied to the bottom surface of the diaphragm 32.

The strain gauges 35-1 to 35-4 make up a Wheatstone bridge circuit for measuring an absolute pressure together with an external circuit, that is, a detection circuit that outputs a signal corresponding to a displacement of the diaphragm 33 having received an absolute pressure. With the Wheatstone bridge circuit for measuring an absolute pressure, it is possible to measure the absolute pressure of the first pressure applied to the top surface of the diaphragm 33.

Since the configuration of each Wheatstone bridge circuit is a known technique, the detailed description is omitted.

In this way, in the present embodiment, it is possible to measure a differential pressure and an absolute pressure at a time with high sensitivity. In the present embodiment, by forming the pressure inlet passages and the pressure inlet chambers in the base 2, the pressure sensing member 3, and the lid member 4 with a fine processing technology, it is possible to reduce the sizes of the pressure inlet chambers (recessed portions 30, 31, 40, 41) from the existing order of millimeters to the order of micrometers. In the present embodiment, the difference between the volume of the pressure inlet passages and the pressure inlet chambers for introducing the first oil (the total volume of the through-holes 21, 37, the groove 42, and the recessed portions 40, 41) and the volume of the pressure inlet passages and the pressure inlet chamber for introducing the second oil (the total volume of the through-hole 20, the groove 36, and the recessed portion 30) is reduced as compared to the existing one. Therefore, the difference between the amount of the first oil and the amount of the second oil is reduced. Hence, it is possible to reduce a characteristic change (shift of zero point for a differential pressure) due to oil expansion and contraction resulting from a temperature change.

In the present embodiment, the adjacent two diaphragms 32, 33 are integrated in one chip, so it is possible to uniform the sensitivities of the diaphragms 32, 33, with the result that calibration is simplified.

### Second Embodiment

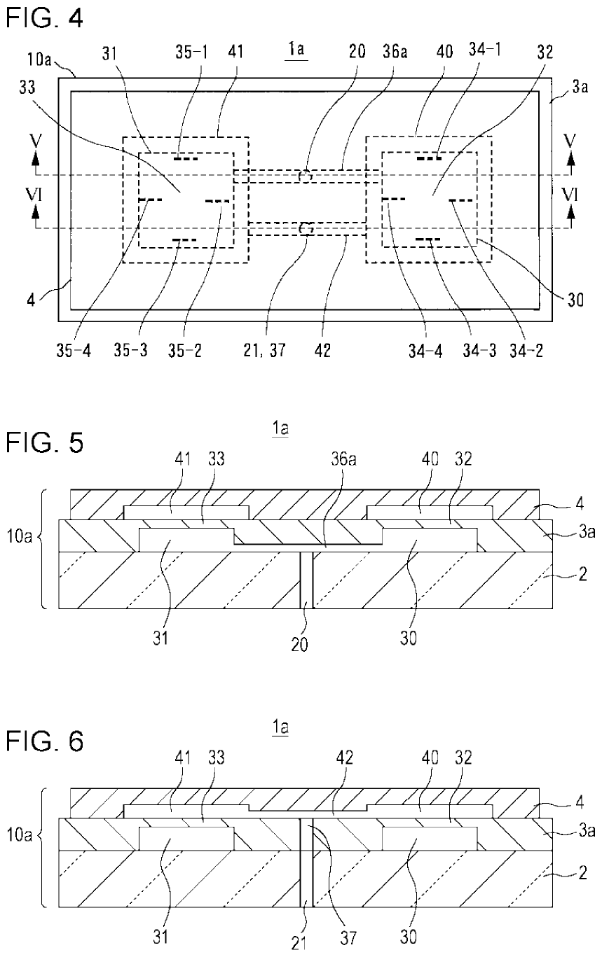

Next, a second embodiment of the present disclosure will be described. FIG. 4 is a plan view of a sensor element according to the second embodiment of the present disclosure. FIG. 5 is a cross-sectional view taken along the line V-V in FIG. 4. FIG. 6 is a cross-sectional view taken along the line VI-VI in FIG. 4. The present embodiment is an example of measuring two differential pressures at a time.

The sensor element la of the present embodiment is made up of a planar sensor chip 10a. The sensor chip 10a is made up of a planar base 2 made of glass, a planar pressure sensing member 3a made of silicon and joined with the base 2, and a planar lid member 4 made of silicon and joined with the pressure sensing member 3a. The base 2 and the lid member 4 are those as described in the first embodiment. As in the case of the first embodiment, the pressure sensing member 3a has two recessed portions 30, 31, two diaphragms 32, 33, eight strain gauges 34-1 to 34-4, 35-1 to 35-4, and a through-hole 37.

In addition, a groove 36a that serves as a pressure inlet passage is formed on the back surface of the pressure sensing member 3a. One end of the groove 36a communicates with the recessed portion 30, the other end of the groove 36a communicates with the recessed portion 31, and, when the base 2 and the pressure sensing member 3a are joined with each other, the middle portion of the groove 36a communicates with the through-hole 20.

The through-holes 21, 37, the groove 42, and the recessed portions 40, 41 make up a first pressure inlet passage that transmits a first pressure to first main surfaces (top surfaces) of the diaphragms 32, 33. The through-hole 20, the groove 36a, and the recessed portions 30, 31 make up a second pressure inlet passage that transmits a second pressure to second main surfaces (bottom surfaces) of the diaphragms 32, 33. Oil is sealed in the first and second pressure inlet passages as will be described later.

The base 2 and the pressure sensing member 3a are directly joined with each other such that the through-hole 20 of the base 2 and the groove 36a of the pressure sensing member 3a communicate with each other.

The pressure sensing member 3a and the lid member 4 are directly joined with each other such that the recessed portions 40, 41 of the lid member 4 respectively cover the diaphragms 32, 33 of the pressure sensing member 3a and the through-hole 37 of the pressure sensing member 3a and the groove 42 of the lid member 4 communicate with each other.

As in the case of the first embodiment, first oil (pressure transmission medium) is able to reach the top surfaces of the diaphragms 32, 33 via the through-holes 21, 37, the groove 42, and the recessed portions 40, 41. The first oil transmits an applied first pressure to the top surfaces of the diaphragms 32, 33. Second oil (pressure transmission medium) is able to reach the bottom surfaces of the diaphragms 32, 33 via the through-hole 20, the groove 36a, and the recessed portions 30, 31. The second oil transmits an applied second pressure to the bottom surfaces of the diaphragms 32, 33.

The strain gauges 34-1 to 34-4 make up a Wheatstone bridge circuit for measuring a differential pressure between the first pressure and the second pressure together with an external circuit, that is, a detection circuit that outputs a signal corresponding to a displacement of the diaphragm 32 having received a differential pressure. The strain gauges 35-1 to 35-4 make up another Wheatstone bridge circuit for measuring a differential pressure together with an external circuit, that is, a detection circuit that outputs a signal corresponding to a displacement of the diaphragm 33 having received a differential pressure.

In this way, in the present embodiment, as in the case of the first embodiment, the difference between the amount of the first oil and the amount of the second oil is reduced, so it is possible to reduce a characteristic change (shift of zero point for a differential pressure) due to oil expansion and contraction resulting from a temperature change.

In the first embodiment and the present embodiment, the diaphragms 32, 33 have the same size. In the present embodiment, the same differential pressure is measured by the two diaphragms 32, 33, so the sizes of the diaphragms 32, 33 may be changed to vary the sensitivities of the diaphragms 32, 33 for measuring a differential pressure.

### Third Embodiment

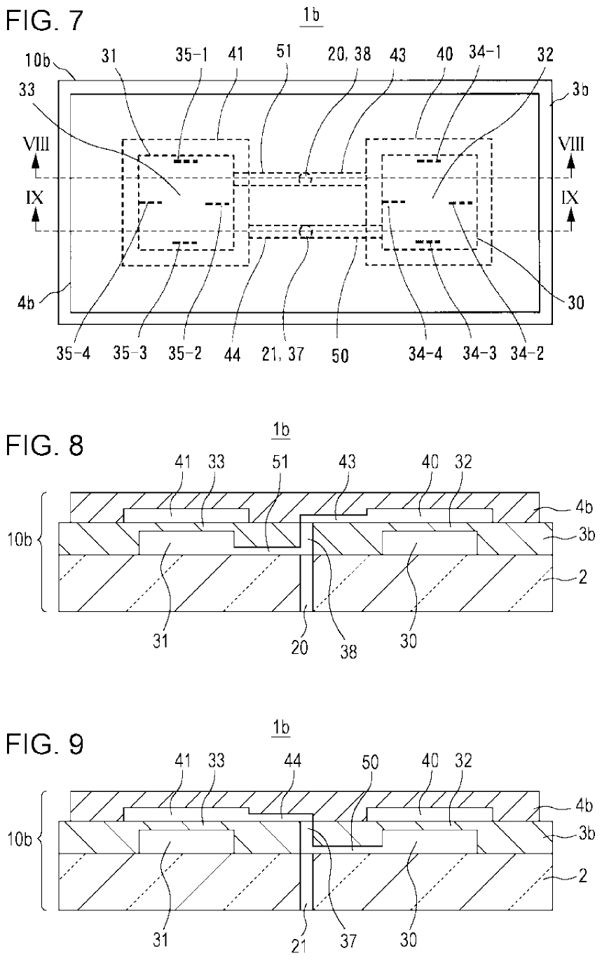

Next, a third embodiment of the present disclosure will be described. FIG. 7 is a plan view of a sensor element according to the third embodiment of the present disclosure. FIG. 8 is a cross-sectional view taken along the line VIII-VIII in FIG. 7. FIG. 9 is a cross-sectional view taken along the line IX-IX in FIG. 7. The present embodiment is another example of measuring two differential pressures at a time.

The sensor element lb of the present embodiment is made up of a planar sensor chip 10b. The sensor chip 10b is made up of a planar base 2 made of glass, a planar pressure sensing member 3b made of silicon and joined with the base 2, and a planar lid member 4b made of silicon and joined with the pressure sensing member 3b. The base 2 is that as described in the first embodiment.

As in the case of the first embodiment, the pressure sensing member 3b has two recessed portions 30, 31, two diaphragms 32, 33, eight strain gauges 34-1 to 34-4, 35-1 to 35-4, and a through-hole 37.

The pressure sensing member 3b has a through-hole 38 at a location where, when the base 2 and the pressure sensing member 3b are joined with each other, the through-hole 38 communicates with the through-hole 20. The through-hole 38 extends through the pressure sensing member 3b from the back surface to the front surface and serves as a pressure inlet passage.

In addition, a groove 50 that serves as a pressure inlet passage and a groove 51 that serves as a pressure inlet passage are formed on the back surface of the pressure sensing member 3b. One end of the groove 50 communicates with the recessed portion 30, and the other end of the groove 50 communicates with the through-hole 37. One end of the groove 51 communicates with the recessed portion 31, and the other end of the groove 51 communicates with the through-hole 38. In this way, one ends of the two grooves 50, 51 respectively communicate with the different recessed portions 30, 31, and the other ends of the two grooves 50, 51 respectively communicate with the different through-holes 37, 38.

As in the case of the first embodiment, the lid member 4b has two recessed portions 40, 41. A groove 43 that serves as a pressure inlet passage and a groove 44 that serves as a pressure inlet passage are formed on the back surface of the lid member 4b. One end of the groove 43 communicates with the recessed portion 40, and, when the pressure sensing member 3b and the lid member 4b are joined with each other, the other end of the groove 43 communicates with the through-hole 38. One end of the groove 44 communicates with the recessed portion 41, and, when the pressure sensing member 3b and the lid member 4b are joined with each other, the other end of the groove 44 communicates with the through-hole 37. In this way, one ends of the two grooves 43, 44 respectively communicate with the different recessed portions 40, 41, and the other ends of the two grooves 43, 44 respectively communicate with the different through-holes 37, 38.

The through-holes 20, 38, the grooves 43, 51, and the recessed portions 40, 31 make up a first pressure inlet passage that transmits a first pressure to a first main surface (top surface) of the diaphragm 32 and a first main surface (bottom surface) of the diaphragm 33. The through-holes 21, 37, the grooves 44, 50, and the recessed portions 30, 41 make up a second pressure inlet passage that transmits a second pressure to a second main surface (bottom surface) of the diaphragm 32 and a second main surface (top surface) of the diaphragm 33. Oil is sealed in the first and second pressure inlet passages as will be described later.

The base 2 and the pressure sensing member 3b are directly joined with each other such that the through-holes 20, 21 of the base 2 and the through-holes 38, 37 of the pressure sensing member 3b respectively communicate with each other.

The pressure sensing member 3b and the lid member 4b are directly joined with each other such that the recessed portions 40, 41 of the lid member 4b respectively cover the diaphragms 32, 33 of the pressure sensing member 3b, the through-hole 37 of the pressure sensing member 3b and the groove 44 of the lid member 4b communicate with each other, and the through-hole 38 of the pressure sensing member 3b and the groove 43 of the lid member 4b communicate with each other.

First oil (pressure transmission medium) reaches the top surface of the diaphragm 32 via the through-holes 20, 38, the groove 43, and the recessed portion 40. First oil reaches the bottom surface of the diaphragm 33 via the through-hole 20, the groove 51, and the recessed portion 31. The first oil transmits an applied first pressure to the top surface of the diaphragm 32 and the bottom surface of the diaphragm 33.

Second oil reaches the bottom surface of the diaphragm 32 via the through-hole 21, the groove 50, and the recessed portion 30. Second oil (pressure transmission medium) reaches the top surface of the diaphragm 33 via the through-holes 21, 37, the groove 44, and the recessed portion 41. The second oil transmits an applied second pressure to the bottom surface of the diaphragm 32 and the top surface of the diaphragm 33.

The strain gauges 34-1 to 34-4 make up a Wheatstone bridge circuit for measuring a differential pressure between the first pressure and the second pressure together with an external circuit, that is, a detection circuit that outputs a signal corresponding to a displacement of the diaphragm 32 having received a differential pressure. The strain gauges 35-1 to 35-4 make up another Wheatstone bridge circuit for measuring a differential pressure together with an external circuit, that is, a detection circuit that outputs a signal corresponding to a displacement of the diaphragm 33 having received a differential pressure.

In this way, in the present embodiment, as in the case of the first embodiment, the difference between the amount of the first oil and the amount of the second oil is reduced, so it is possible to reduce a characteristic change (shift of zero point for a differential pressure) due to oil expansion and contraction resulting from a temperature change.

In the present embodiment, the diaphragms 32, 33 have the same size. As in the case of the second embodiment, the sizes of the diaphragms 32, 33 may be changed to vary the sensitivities of the diaphragms 32, 33 for measuring a differential pressure.

### Fourth Embodiment

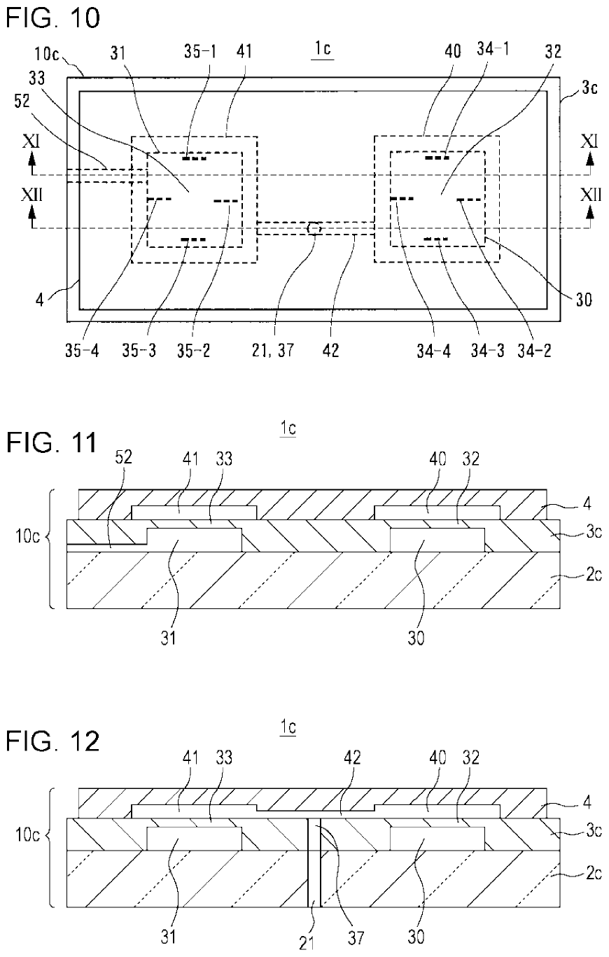

Next, a fourth embodiment of the present disclosure will be described. FIG. 10 is a plan view of a sensor element according to the fourth embodiment of the present disclosure. FIG. 11 is a cross-sectional view taken along the line XI-XI in FIG. 10. FIG. 12 is a cross-sectional view taken along the line XII-XII in FIG. 10. The present embodiment is an example of measuring an absolute pressure and a gauge pressure at a time.

The sensor element 1c of the present embodiment is made up of a planar sensor chip 10c. The sensor chip 10c is made up of a planar base 2c made of glass, a planar pressure sensing member 3c made of silicon and joined with the base 2c, and a planar lid member 4 made of silicon and joined with the pressure sensing member 3c. The lid member 4 is that as described in the first embodiment.

The base 2c has a through-hole 21 that extends through the base 2c from the back surface to the front surface and that serve as a pressure inlet passage.

As in the case of the first embodiment, the pressure sensing member 3c has two recessed portions 30, 31, two diaphragms 32, 33, eight strain gauges 34-1 to 34-4, 35-1 to 35-4, and a through-hole 37.

A groove 52 that serves as a pressure inlet passage is formed on the back surface of the pressure sensing member 3c. One end of the groove 52 communicates with the recessed portion 31, and the other end of the groove 52 is open at the side surface of the pressure sensing member 3c.

The through-holes 21, 37, the groove 42, and the recessed portions 40, 41 make up a first pressure inlet passage that transmits a pressure to first main surfaces (top surfaces) of the diaphragms 32, 33. The groove 52 and the recessed portion 31 make up a second pressure inlet passage that introduces atmospheric pressure to a second main surface (bottom surface) of the diaphragm 33. Oil is sealed in the first pressure inlet passage as will be described later.

The base 2c and the pressure sensing member 3c are directly joined with each other such that the through-hole 21 of the base 2c and the through-hole 37 of the pressure sensing member 3c communicate with each other.

The pressure sensing member 3c and the lid member 4 are directly joined with each other such that the recessed portions 40, 41 of the lid member 4 respectively cover the diaphragms 32, 33 of the pressure sensing member 3c and the through-hole 37 of the pressure sensing member 3c and the groove 42 of the lid member 4 communicate with each other.

First oil (pressure transmission medium) is able to reach the top surfaces of the diaphragms 32, 33 via the through-holes 21, 37, the groove 42, and the recessed portions 40, 41. The recessed portion 30 on the bottom surface of the diaphragm 32 is hermetically sealed in a vacuum state. The atmospheric pressure is transmitted to the bottom surface of the diaphragm 33 via the groove 52 and the recessed portion 31.

The strain gauges 34-1 to 34-4 make up a Wheatstone bridge circuit for measuring an absolute pressure together with an external circuit, that is, a detection circuit that outputs a signal corresponding to a displacement of the diaphragm 32 having received an absolute pressure. With the Wheatstone bridge circuit for measuring an absolute pressure, it is possible to measure the absolute pressure of the first pressure applied to the top surface of the diaphragm 32.

The strain gauges 35-1 to 35-4 make up a Wheatstone bridge circuit for measuring a gauge pressure together with an external circuit, that is, a detection circuit that outputs a signal corresponding to a displacement of the diaphragm 33 having received a gauge pressure. With the Wheatstone bridge circuit for measuring a gauge pressure, it is possible to measure the gauge pressure of the first pressure applied to the top surface of the diaphragm 33.

In this way, in the present embodiment, it is possible to measure an absolute pressure and a gauge pressure at a time with high accuracy.

### Fifth Embodiment

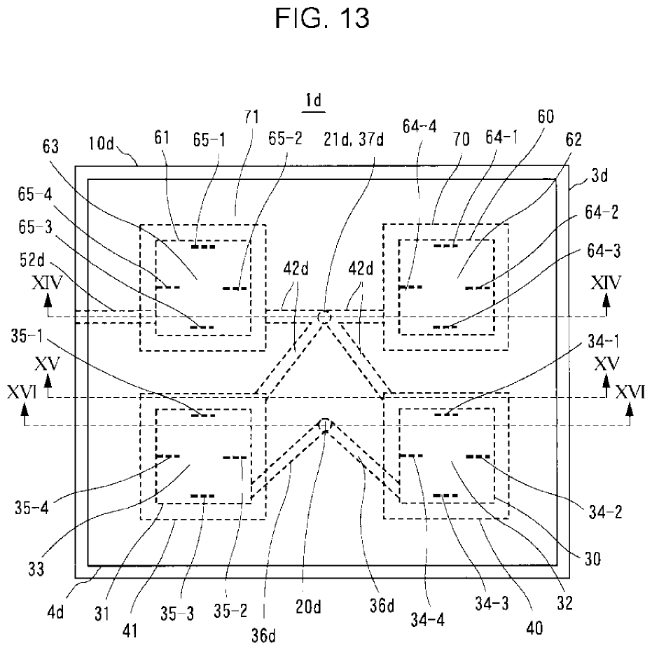

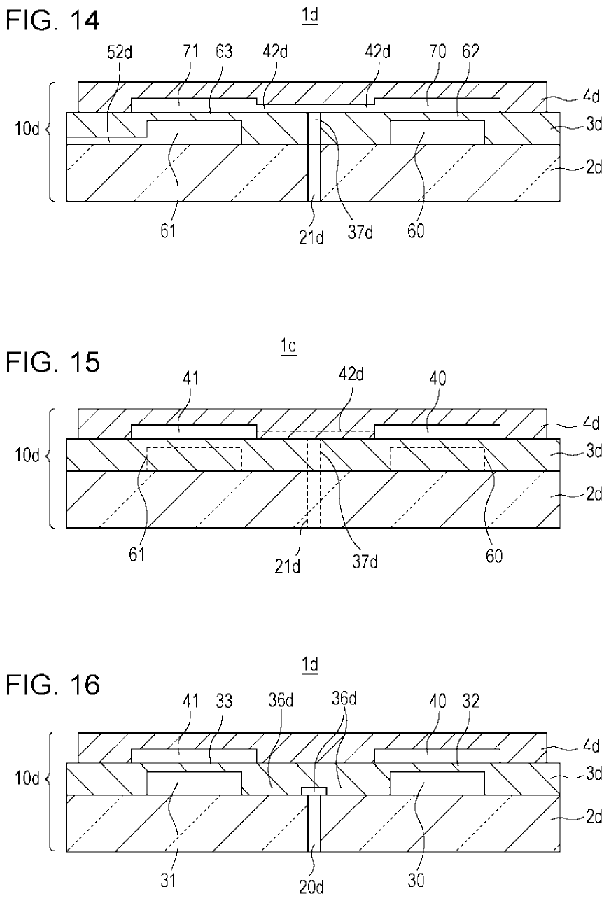

Next, a fifth embodiment of the present disclosure will be described. FIG. 13 is a plan view of a sensor element according to the fifth embodiment of the present disclosure. FIG. 14 is a cross-sectional view taken along the line XIV-XIV in FIG. 13. FIG. 15 is a cross-sectional view taken along the line XV-XV in FIG. 13. FIG. 16 is a cross-sectional view taken along the line XVI-XVI in FIG. 13. The present embodiment is an example including four diaphragms.

The sensor element 1d of the present embodiment is made up of a planar sensor chip 10d. The sensor chip 10d is made up of a planar base 2d made of glass, a planar pressure sensing member 3d made of silicon and joined with the base 2d, and a planar lid member 4d made of silicon and joined with the pressure sensing member 3d.

The base 2d has two through-holes 20d, 21d that extend through the base 2d from the back surface (bottom surface) to the front surface (top surface) and that serve as pressure inlet passages.

Four square recessed portions 30, 31, 60, 61 (pressure inlet chambers) are formed on the back surface of the pressure sensing member 3d, facing the base 2d. The recessed portions 30, 31, 60, 61 are formed by removing part of the back surface side of the pressure sensing member 3d such that the front surface side of the pressure sensing member 3d is left. Portions of the pressure sensing member 3d on the front surface sides of regions where the recessed portions 30, 31, 60, 61 are formed serve as diaphragms 32, 33, 62, 63.

A groove 36d that serves as a pressure inlet passage is formed on the back surface of the pressure sensing member 3d. One end of the groove 36d communicates with the recessed portion 30, the other end of the groove 36d communicates with the recessed portion 31, and, when the base 2d and the pressure sensing member 3d are joined with each other, the middle portion of the groove 36d communicates with the through-hole 20d.

The pressure sensing member 3d has a through-hole 37d at a location where, when the base 2d and the pressure sensing member 3d are joined with each other, the through-hole 37d communicates with the through-hole 21d. The through-hole 37d extends through the pressure sensing member 3d from the back surface to the front surface and serves as a pressure inlet passage.

Strain gauges 34-1 to 34-4, 35-1 to 35-4, 64-1 to 64-4, 65-1 to 65-4 are formed by a technique, such as impurity diffusion and ion implantation, at the peripheral portions of the diaphragms 32, 33, 62, 63 formed on the front surface sides of the regions of the recessed portions 30, 31, 60, 61 on the front surface of the pressure sensing member 3d, facing the lid member 4d. The strain gauges 34-1 to 34-4, 35-1 to 35-4, 64-1 to 64-4, 65-1 to 65-4 function as piezoresistive elements.

The strain gauges 34-1 to 34-4 are respectively formed near the middle points of the four sides of the square diaphragm 32 in plan view. The strain gauges 35-1 to 35-4 are respectively formed near the middle points of the four sides of the square diaphragm 33 in plan view. The strain gauges 64-1 to 64-4 are respectively formed near the middle points of the four sides of the square diaphragm 62 in plan view. The strain gauges 65-1 to 65-4 are respectively formed near the middle points of the four sides of the square diaphragm 63 in plan view.

A groove 52d that serves as a pressure inlet passage is formed on the back surface of the pressure sensing member 3d. One end of the groove 52d communicates with the recessed portion 61, and the other end of the groove 52d is open at the side surface of the pressure sensing member 3d.

Four square recessed portions 40, 41, 70, 71 (pressure inlet chambers) are formed on the back surface of the lid member 4d, facing the pressure sensing member 3d, at locations where, when the pressure sensing member 3d and the lid member 4d are joined with each other, the diaphragms 32, 33, 62, 63 are covered. The recessed portions 40, 41, 70, 71 are formed by removing part of the back surface side of the lid member 4d such that the front surface side of the lid member 4d is left.

A groove 42d that serves as a pressure inlet passage is formed on the back surface of the lid member 4d in such a shape that the groove 42d diverges from a center branch point into four portions. Distal ends of the four portions respectively communicate with the recessed portions 40, 41, 70, 71, and, when the pressure sensing member 3d and the lid member 4d are joined with each other, a portion at the center branch point communicates with the through-hole 37d.

The through-holes 21d, 37d, the groove 42d, and the recessed portions 40, 41, 70, 71 make up a first pressure inlet passage that transmits a first pressure to first main surfaces (top surfaces) of the diaphragms 32, 33, 62, 63.

The through-hole 20d, the groove 36d, and the recessed portions 30, 31 make up a second pressure inlet passage that transmits a second pressure to second main surfaces (bottom surfaces) of the diaphragms 32, 33. The groove 52d and the recessed portion 61 make up a third pressure inlet passage that introduces atmospheric pressure to a second main surface (bottom surface) of the diaphragm 63. Oil is sealed in the first and second pressure inlet passages as will be described later.

The base 2d and the pressure sensing member 3d are directly joined with each other such that the through-hole 20d of the base 2d and the groove 36d of the pressure sensing member 3d communicate with each other and the through-hole 21d of the base 2d and the through-hole 37d of the pressure sensing member 3d communicate with each other.

The pressure sensing member 3d and the lid member 4d are directly joined with each other such that the recessed portions 40, 41, 70, 71 of the lid member 4d respectively cover the diaphragms 32, 33, 62, 63 of the pressure sensing member 3d and the through-hole 37d of the pressure sensing member 3d and the groove 42d of the lid member 4d communicate with each other.

First oil (pressure transmission medium) is able to reach the top surfaces of the diaphragms 32, 33, 62, 63 via the through-holes 21d, 37d, the groove 42d, and the recessed portions 40, 41, 70, 71. The first oil transmits an applied first pressure to the top surfaces of the diaphragms 32, 33, 62, 63. Second oil (pressure transmission medium) is able to reach the bottom surfaces of the diaphragms 32, 33 via the through-hole 20d, the groove 36d, and the recessed portions 30, 31. The second oil transmits an applied second pressure to the bottom surfaces of the diaphragms 32, 33. The recessed portion 60 on the bottom surface of the diaphragm 62 is hermetically sealed in a vacuum state. The atmospheric pressure is transmitted to the bottom surface of the diaphragm 63 via the groove 52d and the recessed portion 61.

The strain gauges 34-1 to 34-4 make up a Wheatstone bridge circuit for measuring a differential pressure between the first pressure and the second pressure together with an external circuit, that is, a detection circuit that outputs a signal corresponding to a displacement of the diaphragm 32 having received a differential pressure. The strain gauges 35-1 to 35-4 make up another Wheatstone bridge circuit for measuring a differential pressure together with an external circuit, that is, a detection circuit that outputs a signal corresponding to a displacement of the diaphragm 33 having received a differential pressure. The strain gauges 64-1 to 64-4 make up a Wheatstone bridge circuit for measuring an absolute pressure together with an external circuit, that is, a detection circuit that outputs a signal corresponding to a displacement of the diaphragm 62 having received an absolute pressure. The strain gauges 65-1 to 65-4 make up a Wheatstone bridge circuit for measuring a gauge pressure together with an external circuit, that is, a detection circuit that outputs a signal corresponding to a displacement of the diaphragm 63 having received a gauge pressure.

In this way, in the present embodiment, it is possible to measure a differential pressure between the first pressure and the second pressure, an absolute pressure of the first pressure, and a gauge pressure of the first pressure at a time with high accuracy.

In the present embodiment, the same differential pressure is measured by the two diaphragms 32, 33, so only one of the diaphragms may be used, or the sizes of the diaphragms 32, 33 may be changed to vary the sensitivities of the diaphragms 32, 33 for measuring a differential pressure.

The embodiments of the present disclosure are described in detail above with reference to the accompanying drawings. However, the technical scope of the present disclosure is not limited to those examples. It is apparent that persons having ordinary skill in the art of the present disclosure can conceive various modifications within the scope of the technical idea recited in the appended claims, and the technical scope of the present disclosure, of course, encompasses these modifications.

What is claimed is:

1. A sensor element comprising:
a plurality of diaphragms that are respectively displaced by receiving pressures;
a plurality of pressure inlet passages that respectively transmit same or different pressures to the plurality of diaphragms; and
a plurality of detection circuits that respectively output signals corresponding to displacements of the associated diaphragms, wherein
each of the plurality of pressure inlet passages is filled with a pressure transmission medium capable of transmitting a pressure, and
a pressure is applied through part or all of the plurality of pressure inlet passages to each of the diaphragms.

2. The sensor element according to claim 1, wherein each of the diaphragms is displaced by receiving an absolute pressure or displaced by receiving a differential pressure.

3. The sensor element according to claim 2, wherein the plurality of diaphragms includes the diaphragm that is displaced by receiving an absolute pressure and the diaphragm that is displaced by receiving a differential pressure.

4. The sensor element according to claim 2, wherein all the diaphragms are displaced by receiving absolute pressures or displaced by receiving differential pressures.

5. The sensor element according to claim 1, wherein each of the detection circuits outputs a signal corresponding to a displacement of the diaphragm having received an absolute pressure or a signal corresponding to a displacement of the diaphragm having received a differential pressure.

6. The sensor element according to claim 5, wherein the plurality of detection circuits includes the detection circuit that outputs a signal corresponding to a displacement of the diaphragm having received an absolute pressure and the detection circuit that outputs a signal corresponding to a displacement of the diaphragm having received a differential pressure.

7. The sensor element according to claim 5, wherein all the detection circuits output signals corresponding to displacements of the diaphragms having received absolute pressures or output signals corresponding to displacements of the diaphragms having received differential pressures.

8. The sensor element according to claim 1, wherein the plurality of diaphragms includes the diaphragms having different sizes.

9. The sensor element according to claim 1, wherein all the diaphragms have the same size.

10. The sensor element according to claim 1, wherein the pressure inlet passages and the diaphragms are made of silicon.
